(19) United States
(12) Patent Application Publication
(10) Pub. No.: US 2013/0030959 A1
(43) Pub. Date: Jan. 31, 2013

(54) Real Time Online Searching

(71) Applicant: Jason Gray, Edmonton (CA)

(72) Inventor: Jason Gray, Edmonton (CA)

(21) Appl. No.: 13/558,774

(22) Filed: Jul. 26, 2012

Related U.S. Application Data
(60) Provisional application No. 61/511,687, filed on Jul. 26, 2011.

(51) Int. Cl. G06Q 30/00

(52) U.S. Cl. 705/27.1

(57) ABSTRACT

An apparatus for real-time online search processing for a user over inter-connected computer networks uses a request and a push signal, otherwise known as a “Ping”. These two items allow the system to deliver advertisements to the end user without requiring personal information from the use. The Request form allows the user to detail what they are looking for and the system repeatedly runs a search looking only for new postings. The system does not require or obtain personal information. The system provides in effect a “set-and-forget” function.

This application claims the benefit under 35 USC 119 (e) of Provisional Application 61/511,687 filed Jul. 27 2011.

This invention relates to an apparatus for real time online searching for products and/or services based on requests by a user.

U.S. Pat. No. 7,555,448 (Hseih) issued Jun. 30 2009 and first published as 2003/0167209 on Sep. 4, 2003 discloses a method and system for real-time online search processing over inter-connected computer networks, in which an offline database information is maintained for a plurality of vendor sites from the inter-connected computer networks. The information includes URLs, search form URLs, description of domains, and vendor descriptions, and while the vendor descriptions comprise generalized rules about how product information is organized on each of the vendor sites. Parameters are processed for a price comparison request for a desired product using the information maintained in the offline database whereas price comparison request is received from an online user or buyer and/or from the system of the present invention. Real-time price and product information is then extracted from identified ones of the plurality of vendor sites, wherein the extracted price and product information are in a native language of the site; and the extracted price and product information are displayed to the user

### SUMMARY OF THE INVENTION

It is one object of the invention to provide an apparatus for real time online searching for products and/or services based on requests by a user.

According to one aspect of the invention there is provided an apparatus for real-time online search processing for a user over inter-connected computer networks comprising:

a terminal device arrange for communication over a network, the terminal device having a display and an input for manual input of data into the terminal device by the user;

a server connected through the network to the terminal device;

a data base for receiving and containing for searching information relating to products and/or services available to the user;

the server and the terminal device being arranged to allow the entry by the user of a request for information on a specifically defined one of the products and/or services;

wherein the request does not make use of or require any personal identification of the user such as email, SMS, phone number or demographic information. The user is anonymous to the third party, source site, or vendor;

wherein the server is arranged to repeatedly carry out a search to identify and locate information from the data base corresponding to the request, which information includes new information added to the data base subsequent to the request;

wherein the server and the terminal device are arranged to send through the network a signal to the terminal device indicating that new information is available from the server;

and wherein the server and the terminal device are arranged to make available the new information to the user through the network.

Preferably the server is arranged such that the information supplied to the user includes only new information added to the data base subsequent to the request, that is, the system does display historical information.

Preferably the terminal device comprises a mobile smart phone and the signal comprises a push signal to a mobile smart phone.

Preferably the push signal is generated by the network to the mobile smart phone.

The Apple Push Notification Service is a mobile service created by Apple Inc. that was released with iOS 3.0 on Jun. 17, 2009. It uses push technology through a constantly-open IP connection to forward notifications from the servers of third party applications to the iPhone, iPod Touch and iPad; such notifications may include badges, sounds or custom text alerts.

Apple first announced the service on 9 Jun. 2008 with a slated release for that September; however, as stated by Scott Forstall at the iOS 3.0 preview event on 17 Mar. 2009, the rollout was rolled back in September after a decision to restructure the APNS for scalability purposes due to the allegedly “overwhelming” response to the announcement of the APNS. At both events, Forstall stated that push notifications were a better means to maintain battery life than background processes (which are used for pull technology) as far as receiving notifications are concerned.

Preferably the terminal device is arranged to access the new information from the server through the internet.

Preferably the signal sent to the user at the terminal device is a Ping which provides the final payload that is delivered to the user and serves as both a notification tool and container of information.

Preferably the ping contains information in the form of an URL such that the user can click on the URL which will take them to the originating site where the relevant data resides.

Preferably the request from the user at the terminal device is arranged to identify the user only by an ID value or UUID.

Preferably the UUID is not attached to any other demographic or personal information so that the system is agnostic to the user as to who they are, where they live or the purpose of the request.

Preferably the system is arranged to send push notifications to the terminal device identified by the UUID.

Preferably the system can connect with mature APIs which work in partnership with other sites for mutual benefit and uses a dedicated API.

Preferably the dedicated API allows other sites to connect directly to users and provides a filtering system through which the users control what type of information they receive.

Preferably through the use of API integrations, the system is able to access data in a unique way.

According to a second aspect of the invention there is provided an apparatus for real-time online search processing for a user over inter-connected computer networks comprising:

a computer terminal device arrange for communication over a network, the terminal device having a display and an input for manual input of data into the terminal device by the user;

a server connected through the network to the terminal device;

a data base for receiving and containing for searching information relating to products and/or services available to the user;

the server and the terminal device being arranged to allow the entry by the user of a request for information on a specifically defined products and/or services;

wherein the request does not contain information identifying the user so that the server does not contain the email address, phone number or the SMS address of the user;

wherein the server is arranged to repeatedly carry out a search to identify and locate information from the data base corresponding to the request, which information includes new information added to the data base subsequent to the request;

wherein the server and the terminal device are arranged to send through the network a signal to the terminal device indicating that new information is available from the server;

wherein the signal sent to the terminal device is a Ping which provides the final payload that is delivered to the user and serves as both a notification tool and container of information;

wherein the ping contains information in the form of an URL such that the user can click on the URL which will take them to the originating site where the relevant data resides.

and wherein the server and the terminal device are arranged to make available the new information to the user through the network.

According to a third aspect of the invention there is provided an apparatus for real-time online search processing for a user over inter-connected computer networks comprising:

a terminal device arrange for communication over a network, the terminal device having a display and an input for manual input of data into the terminal device by the user;

a server connected through the network to the terminal device;

a data base for receiving and containing for searching information relating to products and/or services available to the user;

the server and the terminal device being arranged to allow the entry by the user of a request for information on a specifically defined products and/or services;

wherein the request from the user at the terminal device is arranged to identify the user only by an ID value or UUID where the UUID is not attached to any other demographic or personal information so that the system is agnostic to the user as to who they are, where they live or the purpose of the request;

wherein the server is arranged to repeatedly carry out a search to identify and locate information from the data base corresponding to the request, which information includes new information added to the data base subsequent to the request;

wherein the server and the terminal device are arranged to send through the network a signal to the terminal device indicating that new information is available from the server;

and wherein the server and the terminal device are arranged to make available the new information to the user through the network.

### BRIEF DESCRIPTION OF THE DRAWINGS

One embodiment of the invention will now be described in conjunction with the accompanying drawings in which:

FIG. 1A is a global view of the system according to the present invention.

FIG. 1B is a more detailed view on how data is acquired and a ping generated.

FIGS. 2 to 6 show screen captures of steps in the method of use of the apparatus according to the present invention.

### DETAILED DESCRIPTION

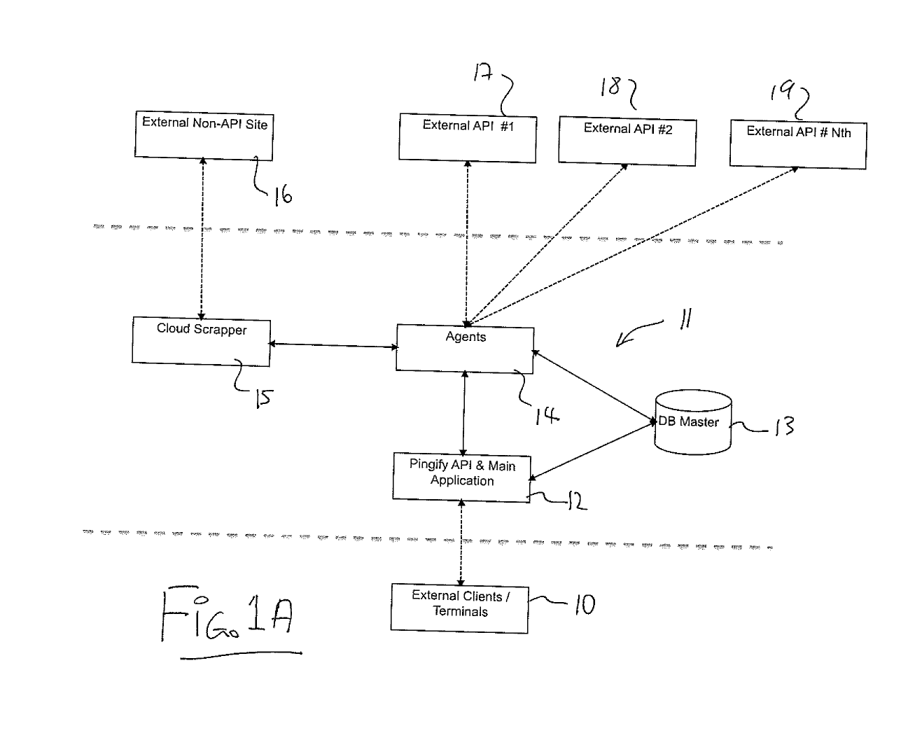

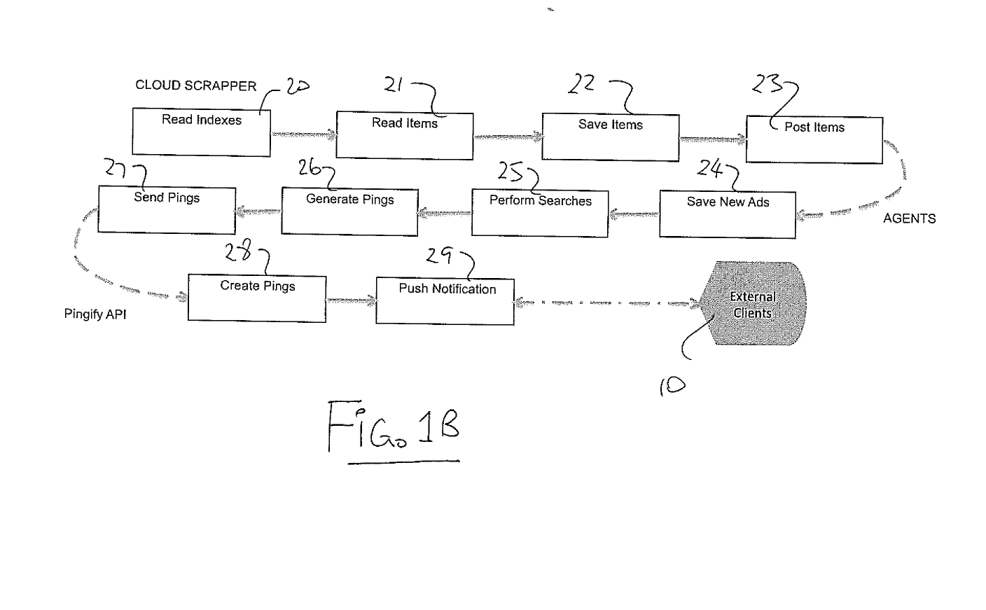

In FIG. 1A, and as described in more detail hereinafter, is shown a global view of the system and in FIG. 1B is a more detailed view in a series of steps described hereinafter on how data is acquired and a ping generated.

Thus in FIG. 1A is shown at 10 a series of external clients which can connect to the system of the present invention indicated at 11. This includes a main application 12 connected to a Data Base 13, a set of Agents 14 and a Cloud scraper 15. The cloud scraper 15 includes a dedicated API which communicates with an external Non-API site 16. The Agents 14 communicate with the external API systems of external data bases.

In one arrangement, the server and the data base can be arranged to repeatedly search the data base for new postings so as to generate said new information from new postings corresponding to the request. That is in a passive system, the server simply repeatedly carries out the search in any new postings which come in from advertisers for items corresponding to the search parameters.

As an alternative in a more active system, the server and the data base can be arranged to post request information corresponding to the request with a view to potential advertisers receiving the request data. Thus the advertisers can then in response post active data so that data received from the advertisers is used to generate said new information from the data received.

The system therefore uses a Request and a push signal, otherwise known as a “Ping”. These two items allow the system to deliver advertisements to the end user without requiring personal information from the user (email address, phone number (related to SMS), mailing address, demographics or browsing habits).

The Request form allows the user to detail what they are looking for (ie. car, house, lawn mower, etc) and if the system has something that matches the Request, a Ping is delivered. Every other form of online and mobile advertising requires, by the very nature of the current technology, to acquire something personal about the user.

The system is unique in that it does not require or obtain personal information.

Another piece of the technology creates in effect a “set-and-forget” function. In all search systems the user creates a search at the time of need. However, the user needs to return to the search and re-input the request. Some systems “save” the search parameters but the user still needs to return to the site and trigger the search.

The information is also displayed on a web interface that the user needs to examine. The present system submits a “Ping” to the user via our application as soon as that information appears in the database. And the system only submits a single “Ping” for that item. For example, if the user is looking for a Ford F-150 $5000-8000 the system will send a “Ping” as each matching Advertisement is posted on the site. The system remains connected to the data base. So if a user puts in a request for the F-150 and a seller submits an Ad that matches, the system sends a “Ping” to the user or potential buyer.

The system does not scrape and display “historical” information like other aggregators. The system only deals with new information as it enters the database. it is a very different system compared to traditional search methods.

The arrangement as described herein may provide one of more of the following features:

A mobile and online advertising technology (targeted notifications).

In other words: a means of reaching, engaging, and ultimately, selling to any target audience.

The Ping application is designed to allow users to create, edit or delete “Requests” and the full sales cycle with the Ping system.

A Request is a fillable form with a series of filters set by the user. These filters can be set “on-the-fly” from the mobile device. There is no need to visit the parent site.

This Request is then compared to the database which houses all of the Vendor's product offerings. If new data has appeared in the system that matches the Request, a Ping is delivered to the user

The Ping contains a brief description of the specific product the user has requested. The user can then click through this Ping and be linked back to a mobile version of the Vendor's eCommerce site.

This provides two-way communications with the consumer where traditional advertising systems are one-way only, typically very vague, and often highly repetitive leading to “information fatigue”.

The pings are specific to the user's wants and needs resulting in more positive response to the Ping notifications which greatly improves the chances of a sale.

The ability to re-connect with current customers to drive them back to the site with highly focused product promotions which greatly improves user retention.

A key feature of the technology is to allow users to “request” specific information via a client application. We required the client application to communication with the core system to create the requests and receive the relevant information in return. There are four platforms that we have identified that require this client: Desktop Computers, iPhone, Blackberry, Android.

The Desktop application needs to be OS agnostic so that it is preferably built in Java. Since the system allows a user to have multiple platforms attached to one account, it has to take into account the synchronization of data and the modification of Requests.

Also, since mobile phones can lose connectivity frequently, the system should provide a means to keep the application running in an offline mode without interrupting the user's activity. There are complex issues that need to be accounted for in this process since asynchronous modifications can potentially destroy records.

The arrangement described herein is a buyer directed lead generation system that collects the buyer's needs through its notification application called Ping Me! By obtaining a buyers' expressed needs with our notification application. The system is able to accumulate a lead database that presents businesses or even individual sellers to potential buyers. By allowing the sellers to hand pick their target buyers, The system provides a propriety notification gateway which can directly connect the buyer to the seller.

The system has turned the sales process on its head by giving the seller direct access to the buyer using highly targeted notifications (or “Branded Pings”). Branded Pings allow the Seller to send notifications tailored specifically for a single buyer or a set of buyers, which ultimately reduces the Seller's cost of sales and increases conversion rates.

The system provides User Controlled Notifications in that a form called a Request is created, edited or deleted by the user. This form is the basis of the Anonymous Notification Target System. Using this form the user can acquire Ad Notifications without revealing any personal information including browsing habits or demographics.

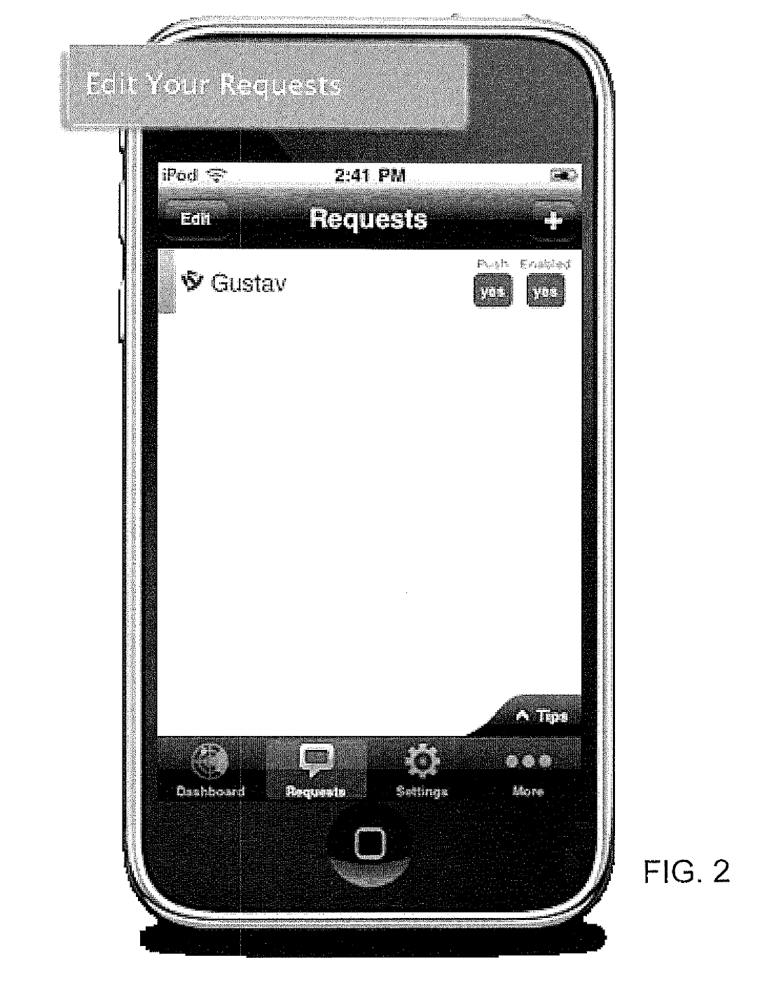

FIGS. 2 to 6 show screen captures of steps in the method of use of the apparatus according to the present invention as follows:

FIG. 2, Edit Requests: The user is able to input specific information about the item they are looking for. The user can customize the following items:

a) Push Notification: the user can decide if they want the request to be “pushed” or arrive using the default “Pull” time frame.

b) Enable Request: If the user wishes to disable the request but not delete it, they can set it here.

c) Feed: the feed specifies the location and category they wish to search.

d) Filter: the filter provides the detailed keywords they wish to search. This includes price range and other specific search functions.

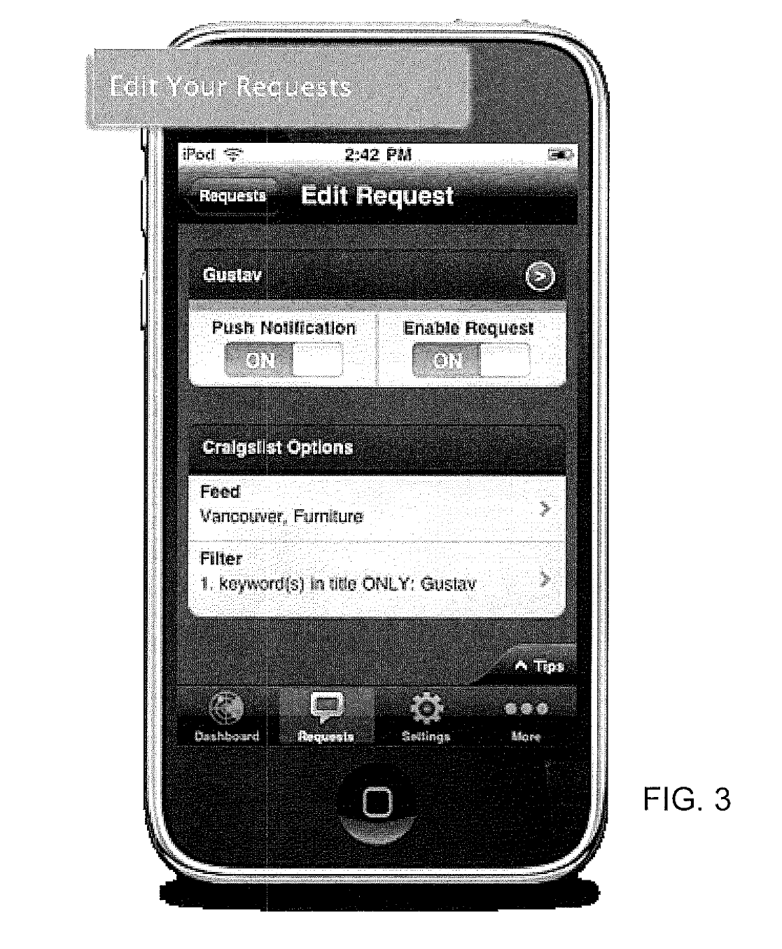

FIG. 3, Dashboard: This page displays the active requests and shows the total number of pings that have been received and the total unread. The user can click on the request to view the pings.

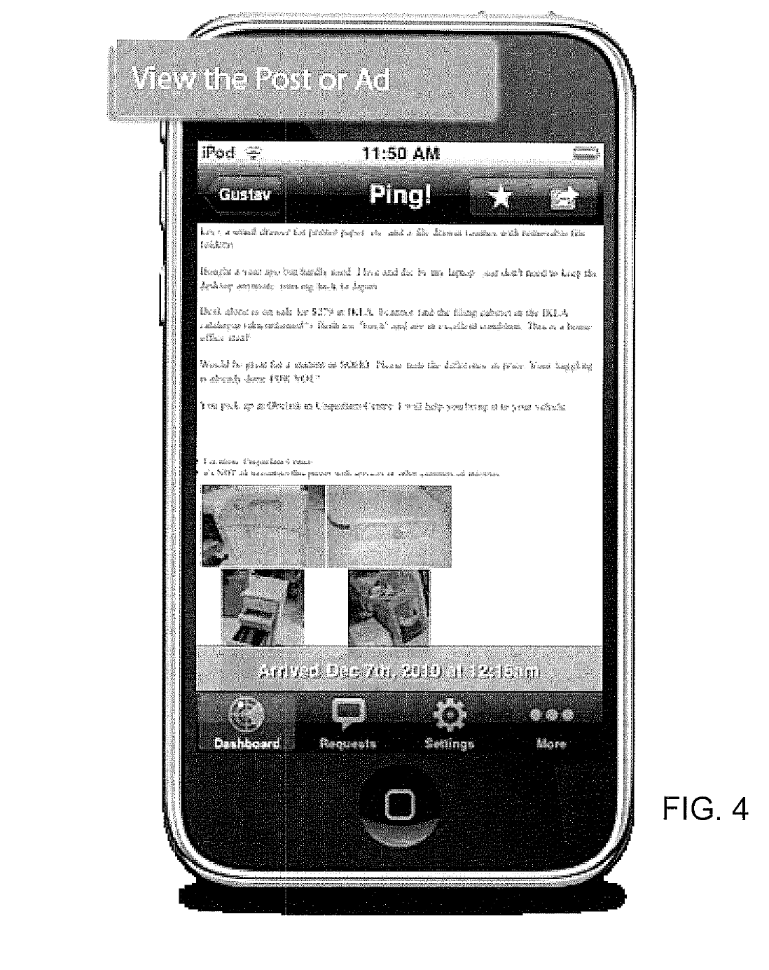

FIG. 4, Requests: This page displays the status of each request and allows the user to Add, Delete or Modify any request.

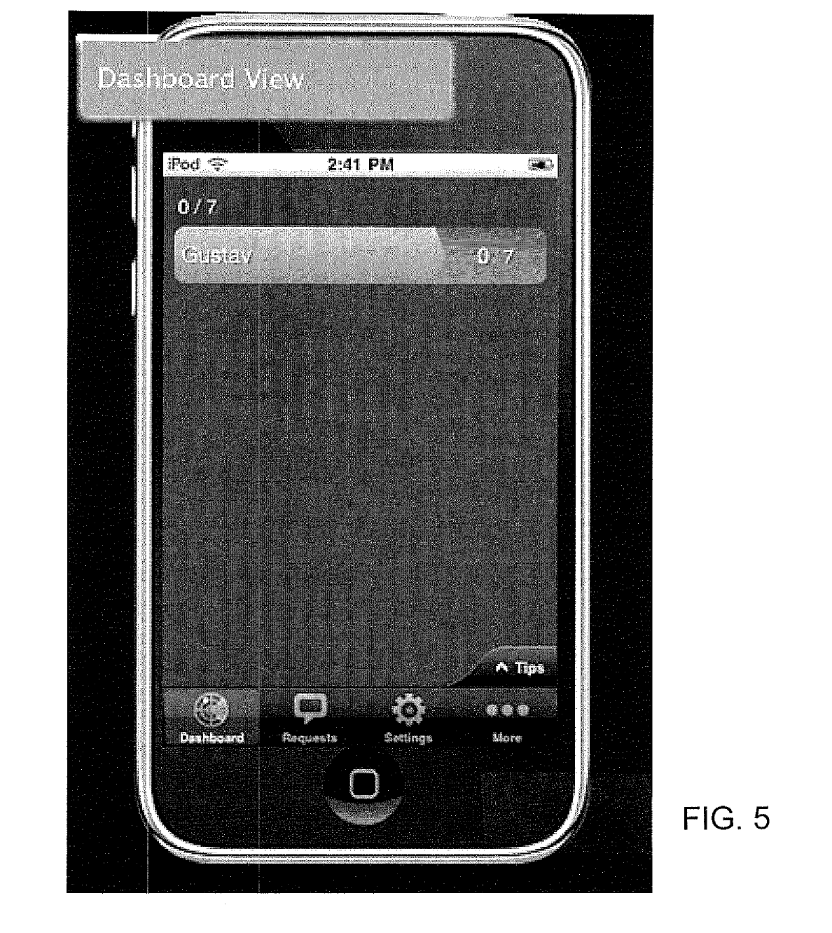

FIG. 5, Pings: This page displays the Pings for each request. The user can display the Pings by Read, Unread, starred or ALL. The user can click on the Ping to view the relevant information they have requested.

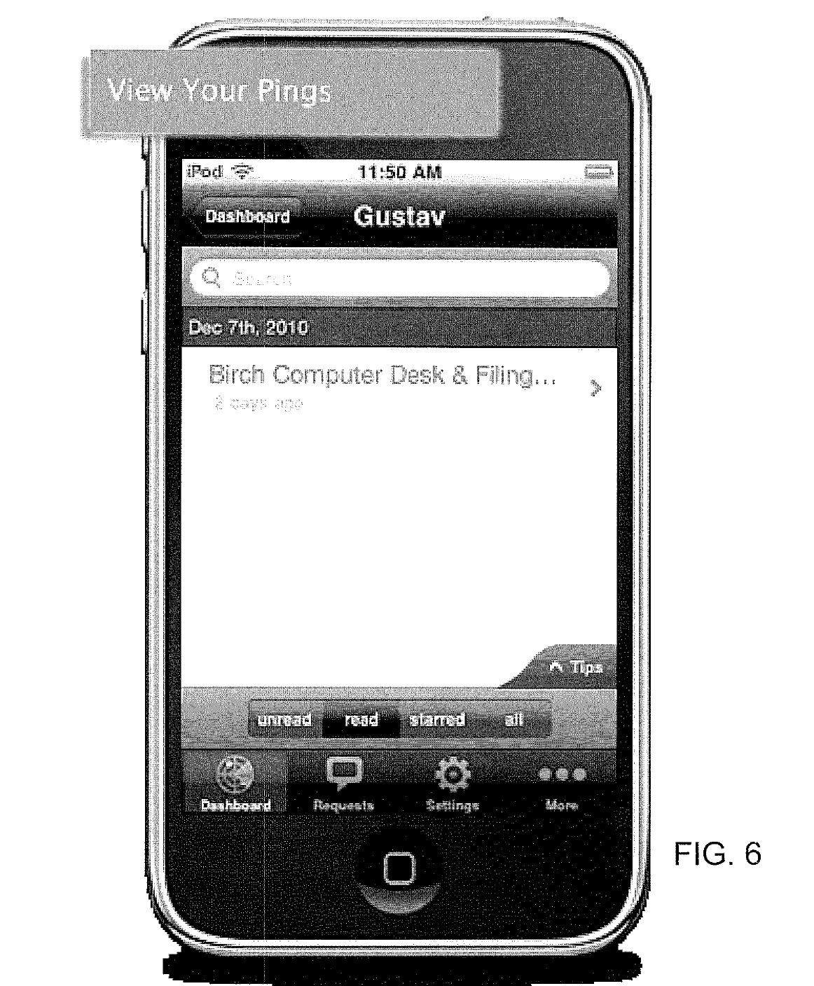

FIG. 6, Ping: This page displays the relevant information that they have requested.

The system herein is based upon the acquisition of data similar to standard search engines. Standard methods include computer bots, scrapers and spiders. The standard method is to retain this information for future searches of historical information. In other words, the data is obtained at the interval set by the programmers of the bot. However, data that is available via form input or sites that require passwords are not available to standard search engines.

The system herein uses both the standard method of data acquisition along with API (Application Programmable Interface) integrations with participating web sites to gather information. Through the use of API integrations, the system is able to access data in a unique way.

### 1) Data Acquisition

Scraping is the standard method of accessing data from third-party websites. To achieve this, the system has created four types of workers that grab the data, process it and then deliver it to the next stage of the system. Each worker performs a specific tasks using computer code.

a) Read Indexes step 20. Each page of a site is considered an “index”. The content of each page is recorded in a database using “scraping”. Scraping is a standard method of traversing the content of a page and recording the information. Once the page is indexed the first time, a time and date are recorded. At regular intervals (usually 15 minutes), the page is checked for a change in the date stamp. If the date stamp has changed, the worker re-reads the page and the new content is recorded into the database.

b) Read Items step 21. This worker is tasked with checking for the changes in the content of the page. If a change is detected, the item is saved.

c) Save Items step 22. The page is required to be formatted in a specific way so that it can be searched later on the process:

Id (auto generated from DB)

URL (Universal Resource Locator)

Index_cache_id (defined by code)

Data (Title, body, etc)

d) Post Item step 23. Once the data has been saved, it is posted to the specific “Agent” that controls the search parameters. Each site within the system herein has a unique “Agent” 14 that is tasked with finding the relevant data that the user has requested.

The system herein uses third-party APIs 17, 18, 19 and has developed its own dedicated API at cloud scraper 15. By using both methods, the system can connect with mature APIs and work in partnership with other sites for mutual benefit. In regard to the use of third-Party APIs, many websites are interested in having their data available on as many different computer devices as possible. To achieve this they present their data to other developers using an API. Most require a developer key that allows the site to connect and access the data. The system herein uses this method to acquire some of the data in the system.

In regard to the dedicated API, the system herein provides an API that allows other sites to connect directly to users of the present system. A filtering system provides the method through which the users control what type of information they receive.

### 2) Data Filtering

Once the data has been delivered to the “Agent”, a time-based SQL query is performed on the data using a query defined by the user called a “Request”. This “Request” is saved in a Data Base. The user can access the request via mobile, desktop or other computer devices. Once the request has been entered into the Database, a time-based trigger performs a search of those search terms against the “Saved Items” (see Data Acquisition 1.a.iii). There are four specific agents 14 required to complete this process:

Save new ads at step 24

Perform searches at step 25

Generate pings at step 26

Send pings at step 27

The user application is a computer interface that can be access via desktop or mobile computer devices. There are two major parts to the application:

a) Requests

Requests are search forms that take the form of an SQL query that is saved in the Data Base. It is these forms that are the access automatically by the Agent.

The user application is a key point of the system. All agents 14 connect to the application via the API. This API is open in two directions, that is, to the user and to the Agents. The user is able to add, change or delete any request they have entered into the system. Any “Ping” that has been delivered to the user is accessible with the application and can be read and subsequently deleted if desired. Any change made to a Request is synchronized with the “Agent”.

b) Pings

Pings are the critical payload delivered to the user. It is the form of an URL. There are four workers that perform the specific tasks of managing the user requests:

(i) Send email

A welcome email is sent to the user with a brief description of the service, examples on how to use the system and other important information to get started.

(ii) Register Device

To send push notifications to the device it must register a UUID. This UUID is used then registered with push servers. This is required by the mobile device to be located without requiring the device to check for new data. A UUID is a universally unique identifier which is an identifier standard used in software construction, standardized by the Open Software Foundation (OSF) as part of the Distributed Computing Environment (DCE).

The intent of UUIDs is to enable distributed systems to uniquely identify information without significant central coordination. Anyone can create a UUID and use it to identify something with reasonable confidence that the same identifier will never be unintentionally created by anyone to identify something else. Information labeled with UUIDs can therefore be later combined into a single database without needing to resolve identifier (ID) conflicts.

(iii) Create Ping at step 28

A Ping is the final payload that is delivered to the user. It served as both a notification tool and container of information. This information is in the form of an URL. The user can click on the URL which will take them to the originating site where the relevant data resides.

(iv) Push Notification at step 29

Push notification is necessary so that the device is not required to constantly check for new data.

Using saved “Request” that is defined by a user avoids the requirement to track the browsing and other behavior tracking systems employed by the majority of standard search engines. The user is only defined by an ID value that is not attached to any other demographic or personal information. The system is agnostic to the user and is not aware of who they are, where they live or the purpose of the request.

1. Apparatus for real-time online search processing for a user over inter-connected computer networks comprising:
a terminal device arrange for communication over a network, the terminal device having a display and an input for manual input of data into the terminal device by the user;
a server connected through the network to the terminal device;
a data base for receiving and containing for searching information relating to products and/or services available to the user;
the server and the terminal device being arranged to allow the entry by the user of a request for information on a specifically defined products and/or services;
wherein the request does not contain information identifying the user so that the server does not contain the email address, phone number or the SMS address of the user;
wherein the server is arranged to repeatedly carry out a search to identify and locate information from the data base corresponding to the request, which information includes new information added to the data base subsequent to the request;
wherein the server and the terminal device are arranged to send through the network a signal to the terminal device indicating that new information is available from the server;
and wherein the server and the terminal device are arranged to make available the new information to the user through the network.

2. The apparatus according to claim 1 wherein the server is arranged such that the information supplied to the user includes only new information added to the data base subsequent to the request.

3. The apparatus according to claim 1 wherein the terminal device comprises a mobile smart phone and the signal comprises a push signal to a mobile smart phone.

4. The apparatus according to claim 1 wherein the push signal is generated by the network to the mobile smart phone.

5. The apparatus according to claim 1 wherein the terminal device is arranged to access the new information from the server through the internet.

6. The apparatus according to claim 1 wherein the server and the data base are arranged to repeatedly search the data base for new postings so as to generate said new information from new postings corresponding to the request.

7. The apparatus according to claim 1 wherein the server and the data base are arranged to post request information corresponding to the request and to receive data from parties reviewing said request information so as to generate said new information from the data received.

8. The apparatus according to claim 1 wherein the signal sent to the user at the terminal device is a Ping which provides the final payload that is delivered to the user and serves as both a notification tool and container of information.

9. The apparatus according to claim 8 wherein the ping contains information in the form of an URL such that the user can click on the URL which will take them to the originating site where the relevant data resides.

10. The apparatus according to claim 1 wherein the request from the user at the terminal device is arranged to identify the user only by an ID value or UUID.

11. The apparatus according to claim 10 wherein the UUID is not attached to any other demographic or personal information so that the system is agnostic to the user as to who they are, where they live or the purpose of the request.

12. The apparatus according to claim 10 wherein the system is arranged to send push notifications to the terminal device identified by the UUID.

13. The apparatus according to claim 1 wherein the system can connect with mature APIs which work in partnership with other sites for mutual benefit and uses a dedicated API.

14. The apparatus according to claim 13 wherein the dedicated API allows other sites to connect directly to users and provides a filtering system through which the users control what type of information they receive.

15. The apparatus according to claim 1 wherein through the use of API integrations, the system is able to access data in a unique way.

16. Apparatus for real-time online search processing for a user over inter-connected computer networks comprising:
a computer terminal device arrange for communication over a network, the terminal device having a display and an input for manual input of data into the terminal device by the user;
a server connected through the network to the terminal device;
a data base for receiving and containing for searching information relating to products and/or services available to the user;
the server and the terminal device being arranged to allow the entry by the user of a request for information on a specifically defined products and/or services;
wherein the request does not contain information identifying the user so that the server does not contain the email address, phone number or the SMS address of the user;
wherein the server is arranged to repeatedly carry out a search to identify and locate information from the data base corresponding to the request, which information includes new information added to the data base subsequent to the request;
wherein the server and the terminal device are arranged to send through the network a signal to the terminal device indicating that new information is available from the server;
wherein the signal sent to the terminal device is a Ping which provides the final payload that is delivered to the user and serves as both a notification tool and container of information;
wherein the ping contains information in the form of an URL such that the user can click on the URL which will take them to the originating site where the relevant data resides.
and wherein the server and the terminal device are arranged to make available the new information to the user through the network.

17. Apparatus for real-time online search processing for a user over inter-connected computer networks comprising:
a terminal device arrange for communication over a network, the terminal device having a display and an input for manual input of data into the terminal device by the user;
a server connected through the network to the terminal device;
a data base for receiving and containing for searching information relating to products and/or services available to the user;
the server and the terminal device being arranged to allow the entry by the user of a request for information on a specifically defined products and/or services;
wherein the request from the user at the terminal device is arranged to identify the user only by an ID value or UUID where the UUID is not attached to any other demographic or personal information so that the system is agnostic to the user as to who they are, where they live or the purpose of the request;
wherein the server is arranged to repeatedly carry out a search to identify and locate information from the data base corresponding to the request, which information includes new information added to the data base subsequent to the request;
wherein the server and the terminal device are arranged to send through the network a signal to the terminal device indicating that new information is available from the server;
and wherein the server and the terminal device are arranged to make available the new information to the user through the network.
